(19) United States
(12) Patent Application Publication
(10) Pub. No.: US 2016/0279542 A1
(43) Pub. Date: Sep. 29, 2016

(54) Pond Filter

(71) Applicant: Thomas G. Stroope, Beford, TX (US)

(72) Inventor: Thomas G. Stroope, Beford, TX (US)

(21) Appl. No.: 15/081,845

(22) Filed: Mar. 26, 2016

Related U.S. Application Data
(60) Provisional application No. 62/138,908, filed on Mar. 26, 2015.

(51) Int. Cl. B01D 24/16; B01D 35/26

(52) U.S. Cl. CPC B01D 24/16; B01D 35/26

(57) ABSTRACT

An exemplary embodiment of a pond filter is comprised of a sidewall comprising one or more vertically oriented sections integrally and sealably formed as a series and presenting an interior region further bounded by a bottom wall. A primary filter is sealably joined within the sidewall and spanning the width of the interior of the sidewall, defining an upper chamber and a lower chamber. The primary filter rests on the shoulder, the shoulder presenting a resting surface on the upper edge of the lower chamber. The primary filter includes a plurality of water discharge apertures enabling controlled fluid communication between the upper chamber and lower chamber. An inlet is disposed on the sidewall portion of the lower chamber, whereby a fluid communication channel is defined from the inlet through the lower chamber through the water discharge apertures to the upper chamber where it can overflow back into the pond.

### PRIORITY

The present invention claims priority to provisional application 62/138,908, which has a filing date of Mar. 26, 2015 and is incorporated by reference.

### BACKGROUND

1. Field of the Invention

The present invention generally relates to water filtration systems, specifically for water filtration systems for large contained water bodies.

2. Description of the Related Art

A pond is a frequently used landscaping feature. To obtain the maximum benefit from having such ponds, they should be visually appealing, support plants, and provide a habitat for fish and other creatures such as birds, frogs, butterflies, and the like.

Clear water is a feature desired in most ponds so that fish and submerged plants may be visible. However, maintaining the clarity of the outdoor water can become difficult. Algae, for example, may cause the water to become cloudy. The excessive algae typically occurs when the water contains an excess of chemicals such as ammonia and phosphorous Ammonia and phosphorous is often deposited in the pond water by fish waste and fertilizer runoff from the land surrounding the pond. Although aquatic plants may consume a portion of the nutrients, the number of plants is typically insufficient to handle the amount of excessive nutrients in a pond. Algae, which feed on these nutrients, then multiply due to the abundance of nutrients. This multiplication may result in algae “blooms” which cause the pond water to become turbid.

One method of clarifying water is to add chemicals such as chlorine to the water in order to kill the algae. However, these chemicals may have undesirable side effects such as impacting the number and size of aquatic plants and fish. Also, the chemicals often require frequent reapplication.

### SUMMARY

An exemplary pond filter comprises a sidewall having an upper and lower section, the sidewall forming a perimeter and enclosing an interior region. A bottom wall spans the lower section of the sidewall, the joined sidewall and bottom wall defining an enclosure. A primary filter is sealably joined within the sidewall and spanning the width of the interior of the sidewall, defining an upper chamber and a lower chamber. The primary filter includes a plurality of water discharge apertures enabling controlled fluid communication between the upper chamber and lower chamber. An inlet is disposed on the sidewall portion of the lower chamber, whereby a fluid communication channel is defined from the inlet through the lower chamber through the water discharge apertures to the upper chamber, the fluid entering at the inlet, passing through the primary filter to the upper chamber.

These and other features, aspects, and advantages of the invention will become better understood with reference to the following description, and accompanying drawings.

### BRIEF DESCRIPTION OF THE DRAWINGS

FIGS. 1A depicts a side view of an embodiment according to the current invention;

FIGS. 1B depicts a top view of an embodiment according to the current invention;

FIGS. 1C depicts a side perspective view of an embodiment of FIG. 1A;

FIGS. 1D depicts an alternate side view of an embodiment of FIG. 1A;

FIG. 2 depicts a side view of an embodiment of the current invention;

FIG. 3 depicts a top view of the embodiment of FIG. 2;

FIG. 4 depicts a side view of an embodiment of the current invention as it may exist in operation;

FIG. 5 depicts a partial top view of a portion of an embodiment of the current invention; and

FIGS. 6A-6C depict partial side views of the inlet portion of an embodiment of the current invention as it may exist in operation.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

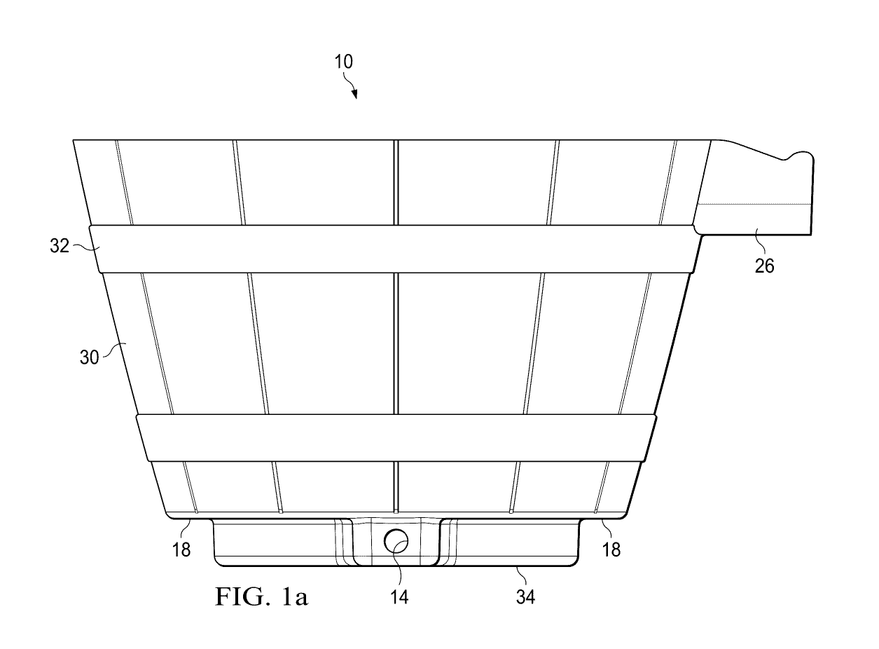

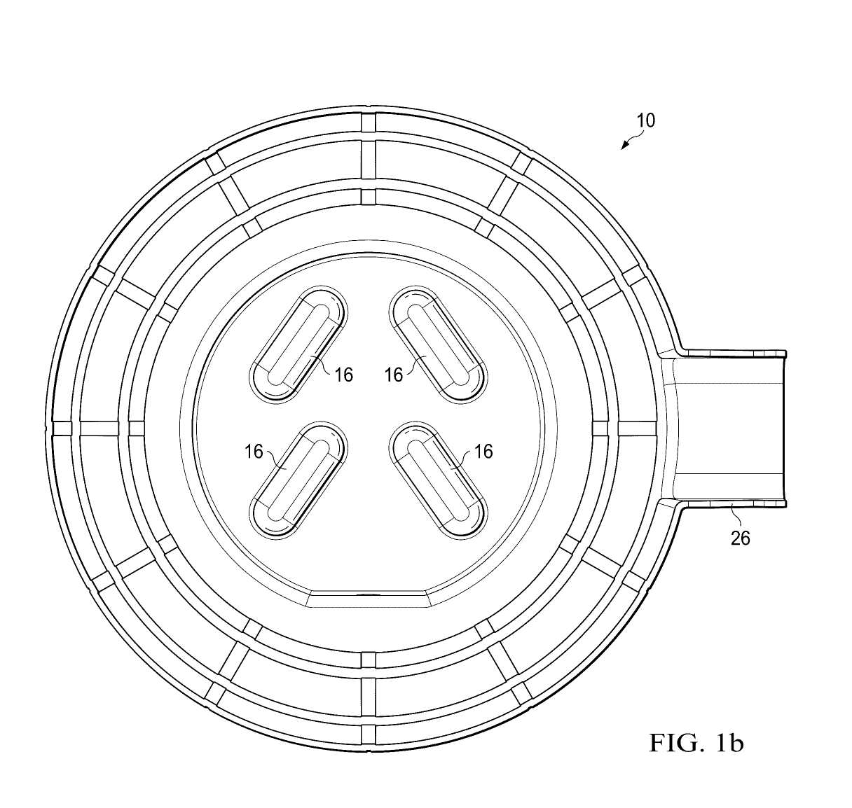

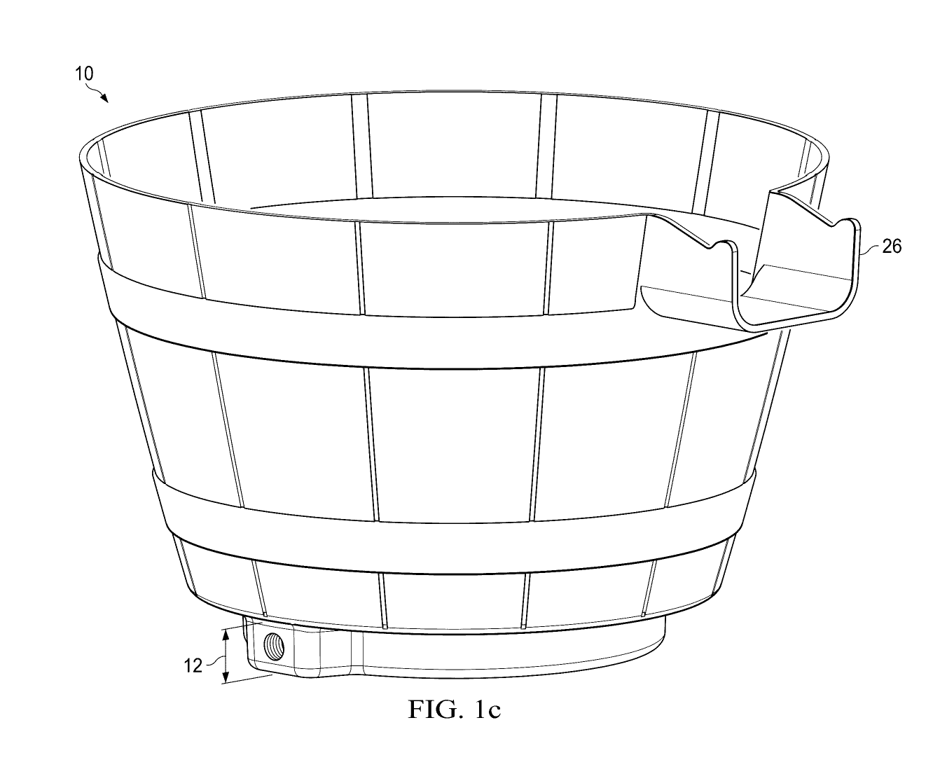

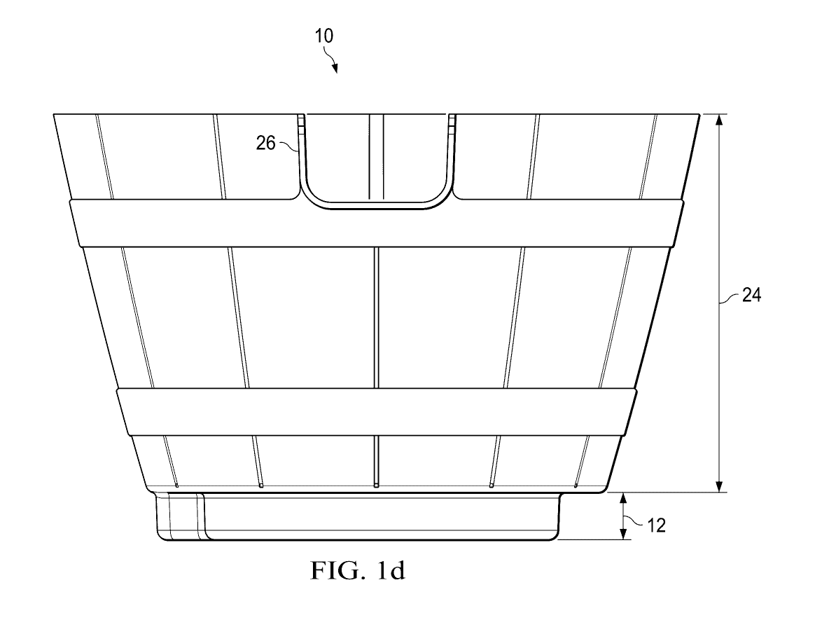

The present invention is directed to a water filter system for large contained water bodies such as ponds. FIGS. 1A-1D illustrate embodiments of pond filters 10 of the present invention. Depicted is a sidewall 30 enclosing an upper chamber 24 and a lower chamber 12.

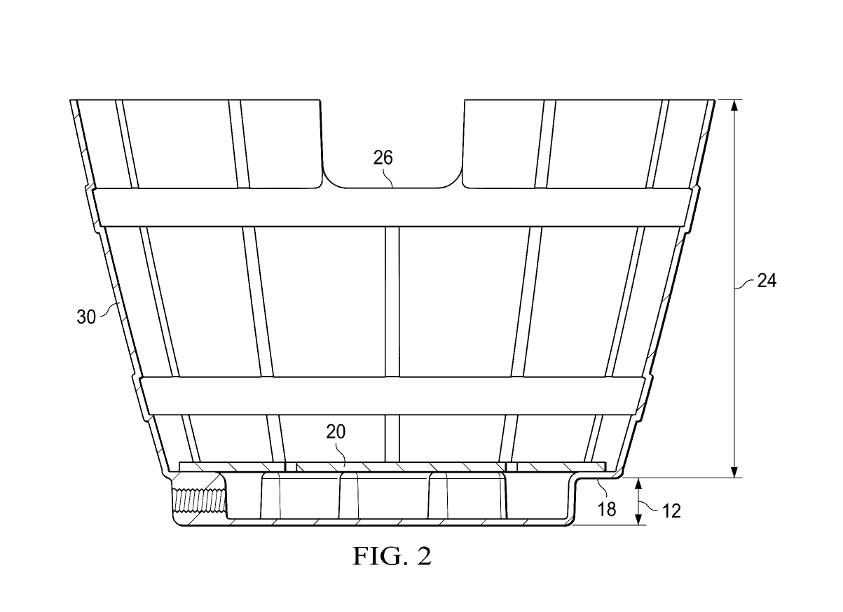

Referring to FIG. 2, the depicted sidewall 30 is one or more vertically oriented sections integrally formed as a series, joined to contain water 06 within the upper chamber 24 and lower chamber 12. In exemplary configurations, the sidewall 30 is unitary, being molded or otherwise formed as a single piece.

FIG. 1B illustrates a top view of an embodiment of the pond filter 10. The illustrated cross-sectional profile is circular, though it is within the scope of the invention to employ other cross-sectional profiles such as rectangular, triangular, or others. Optionally, ribs 32 are secured to the outer surface of the sidewall 30 providing reinforcement. The ribs 32 strengthen sidewalls 30 so that the enclosure can better withstand minor deterioration, temperature changes, and other effects of outdoor exposure. In exemplary configuration, the sidewall 30 is constructed of rigid materials such as metal, wood, fiberglass, plastics (for example, high density polyethylene), or other materials.

The bottom wall 34 is at the bottom of the sidewall 30, spanning the sidewall, with the sidewall 30 and bottom wall 34 defining an enclosure. In exemplary configuration, the bottom wall 34 is composed of the same materials as the sidewall 30 and is integral with the sidewall 30.

As disclosed, the sidewalls 30 enclose an upper chamber 24 and a lower chamber 12. The lower chamber 12 is at the lower end of the sidewall 30 and the depicted configuration has a first width WI across the sidewall and a first height H1 from the bottom wall 34. An inlet 14 is disposed in the lower chamber 12 section of the sidewall 30, operable for slidable receipt of a hose 29 and enabling fluid communication from the exterior of the pond filter 10 to the lower chamber 12. The lower chamber 12 is dimensioned to permit water 06 flow while holding a desired amount of sedimentation between emptying. In further exemplary configuration, the lower chamber 12 is dimensioned to permit water 06 flow with minimal current flow disturbing the settled sedimentation, taking into account the inlet 14 position and other factors.

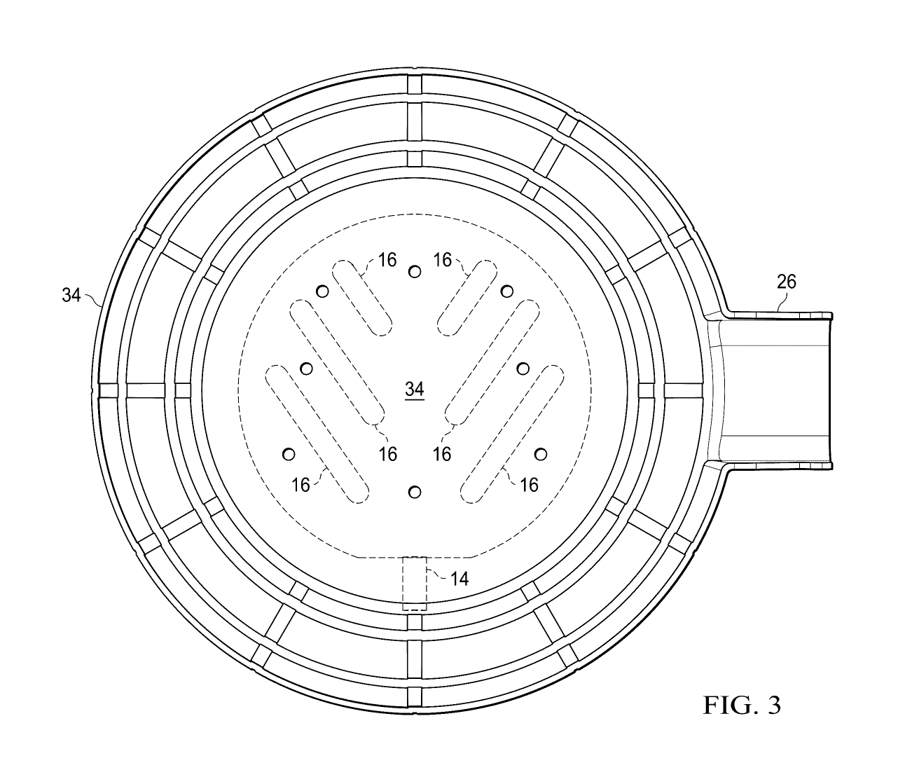

Referring to FIG. 3, in certain configurations, one or more baffles 16 are disposed in the lower chamber 12. The baffles 16 are rigid and operable to bear vertical, downward load. In the depicted configuration, the baffles 16 are integral with and rise upwardly from the bottom wall 34. The height of exemplary baffles 16 is less than the height of the lower chamber 12 and the shoulder 18.

Referring again to FIG. 3, in certain configurations, a shoulder 18 is disposed at the upper end of the lower chamber 12. The exemplary shoulder 18 flares outwardly form width W1 of the lower chamber presenting a resting surface. The shoulder 18 is rigid and in the depicted configuration, the shoulder 18 is integral with the sidewall 30.

The inlet 14 is disposed in the lower chamber 12 of the sidewall 30. The inlet 14 includes an opening from the lower chamber 12 to the exterior of the pond filter 10, providing fluid communication between the lower chamber 12 and the exterior of the pond filter 10. The depicted inlet 14 extends outwardly from the sidewall 30. The exemplary inlet 14 opening width is dimensioned to permit water flow but restrict large debris ingress into the pond filter 10. In such configuration, the inlet 14 restricts large debris such as leaves, branches, or garbage to enter the lower chamber 12.

In various configurations, the inlet 14 is disposed at various positions relative to primary filter 20 and the bottom wall 34. In certain configurations, the inlet 14 is disposed just below the primary filter 20. In certain configurations, the inlet 14 is disposed above the baffles 16. In other configurations, the inlet 14 is disposed inline with the baffles 16.

The exemplary embodiments include a primary filter 20. The illustrated primary filter 20 is dimensioned to rest on the shoulder 18. In exemplary configuration, it is shaped similarly as the cross-sectional profile of the sidewall 30 and dimensioned to span the interior of the sidewall 30. It is further adapted to sealably join to the shoulder 18, presenting a rate flow controlled fluid barrier between the lower chamber 12 and the upper chamber 24.

The primary filter 20 contains one or a plurality of water discharge apertures 22 spaced about it. The primary filter 20 is operable to entrain debris and particulate matter such that it is blocked from passing through and entering the upper chamber 24. The water discharge apertures 22 are permit rate flow controlled fluid communication between the lower chamber 12 and the upper chamber 24, whereby a fluid communication channel is defined from the inlet 14 through the lower chamber 12 through the water discharge apertures 22 to the upper chamber 24. In exemplary configuration, the water discharge apertures 180 are spaced and dimensioned so as to permit water flow to the upper chamber 24, prevent any filter media from falling to the lower chamber 12, and minimize currents in the lower chamber 12 that would tend to disturb the particles such as sedimentation that have settled out. The primary filter 20 is composed of material which enables filtration such as wire mesh, plastic with holes, or other filter media. The baffles 16 are rigid and operable to bear vertical, downward load, providing additional rigidity to and maintaining the position of the primary filter 20 such that a constant volume is maintained in the lower chamber 12.

As disclosed, the sidewalls 30 enclose an upper chamber 24 and a lower chamber 12. The upper chamber 24 is at the upper end of the sidewall 30 above the shoulder 18. The depicted configuration has a second width W2 across the sidewall 30 at the shoulder 18 and a second height H2 from the shoulder 18. In exemplary configuration, width W2 is greater than width W1. The width of the sidewall 30 may vary as it extends upwardly. In certain configurations, the width increases as the distance from the shoulder 18 increases. Optionally, a spout 26 extends outwardly from the upper edge of the upper chamber 24 for directional control of water 06 overflow exiting the pond filter 10.

Certain configurations of the include additional filter media. The filter media is disposed in the upper chamber 24 and is operable to provide mechanical, biological, and/or chemical filtration of water passing through the upper chamber 24. Certain configurations of the pond filter 10 include gravel 08. Exemplary gravel 08 is granular gravel (about 2 to 4 mm), pebble gravel (about 4 to 64 mm), or a combination thereof.

Certain configurations of the pond filter 10 include soil. Exemplary soil are those that have an optimum density, porosity, and biological content for water filtration. For example, various sand, silt, and clay compositions may be employed individually or in combination.

Certain configurations of the pond filter 10 include root mass. Root mass is typically provided by live plants. Different species of plants can absorb different chemicals and have different effects on microbes. Exemplary plants include those have an optimum absorption for water filtration. For example, water lilies (nymphaeaceae), elephant ears (colocasia), and bird of paradise (strelitzia reginae) are representative suitable plant types.

Certain embodiments of the pond filter include a water pump 28 operable to move water from one. The water pump 28 includes a pump in order to move the water from the source 06 into the inlet 14 of the pond filter 10. The hose 29 of the water pump 28 is engaged to the inlet 14.

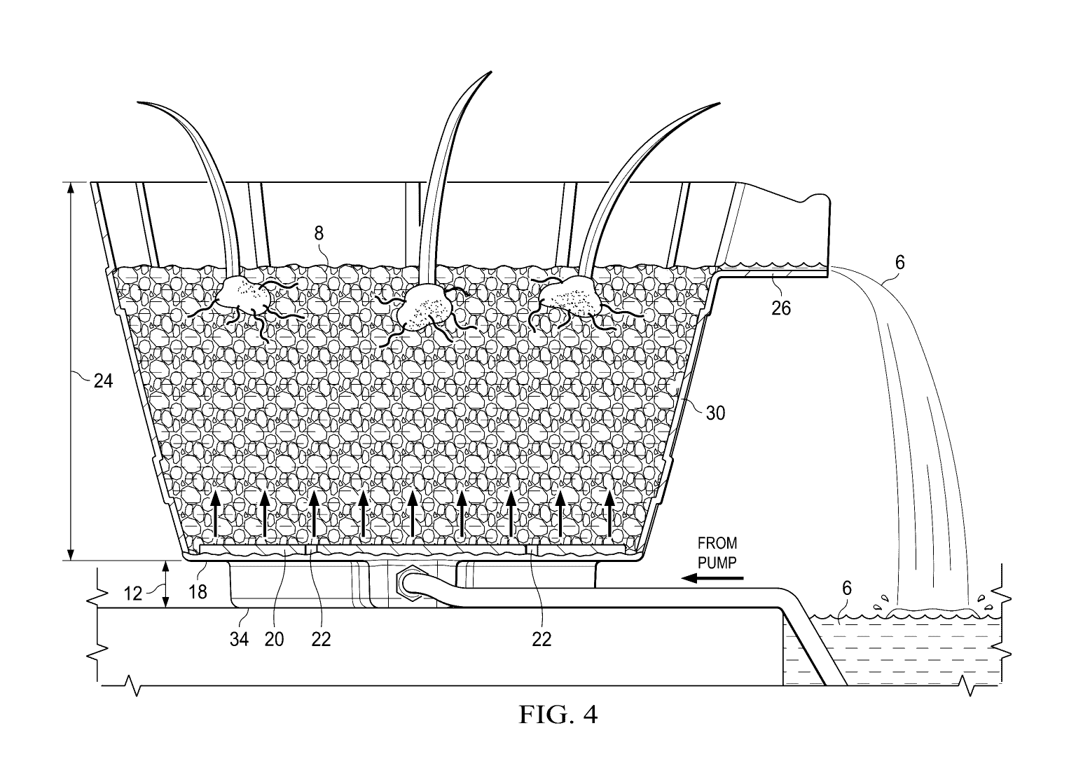

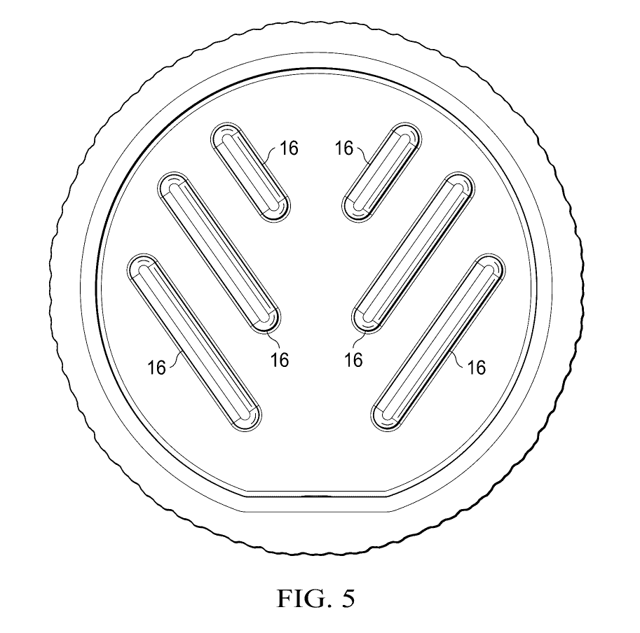

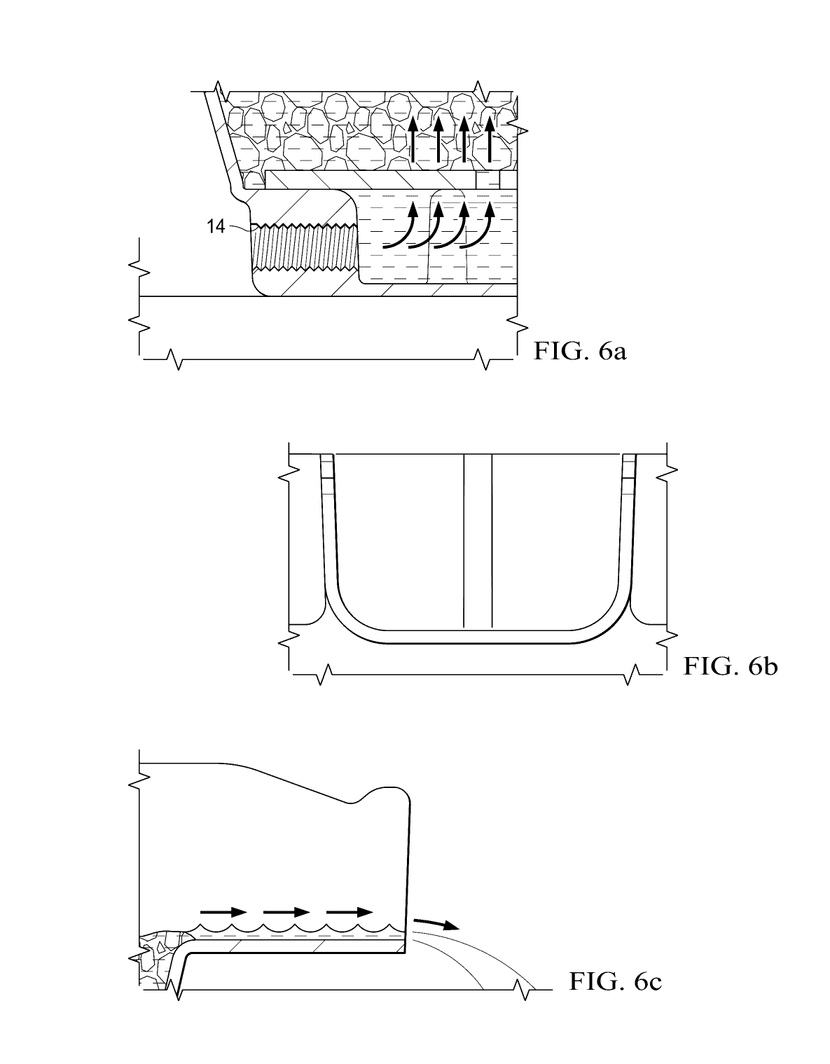

Referring to FIGS. 4-6, use of the pond filter 10 is described. The pond filter 10 and pump 28 are placed adjacent to the water 06 source, as shown in FIG. 4, with the spout 26 oriented to the pond 06. The hose 29 of the pump 28 is slidably joined to the inlet 14 of the lower chamber 12. As shown in FIG. 5, the primary filter 20 is secured to the shoulder 18, with the baffles 16 abutting the bottom of the primary filter 20. As shown in FIG. 4, gravel 08 is placed in the upper chamber 24, serving as additional filtration media. Plants may also be placed in the upper chamber 24, where the root system serves as additional filtration media. The pump 28 is activated and its hose 29 is engaged to the inlet 14. providing positive pressure and accordingly, water flow from the pond water 06 through the hose 29. As shown in FIGS. 6A-6C, the water 06 flows through the hose 29 through the inlet 14 into the lower chamber 12. As shown in FIG. 4, the lower chamber 12 is filled, the sedimentation settles, and the water 06 flows through the water discharge apertures 22 into the upper chamber 24. The water 06 fills the upper chamber 24. As the capacity of the upper chamber 24 is reached, the water 06 overflows through the spout 26 back into the pond 06.

Other embodiments and uses include use as a drain in a plant potting situation, or with attachment of hose, can serve as rain water catcher, could be a fountain.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A pond filter comprising:
a sidewall having an upper and lower section, said sidewall forming a perimeter and enclosing an interior region;
a bottom wall spanning the lower section of said sidewall, joined said sidewall and said bottom wall defining an enclosure;
a primary filter sealably joined within the sidewall and spanning the width of the interior of the sidewall, defining an upper chamber and a lower chamber;
the primary filter including a plurality of water discharge apertures enabling controlled fluid communication between the upper chamber and lower chamber; and
an inlet disposed on the sidewall portion of the lower chamber, whereby a fluid communication channel is defined from the inlet through the lower chamber through the water discharge apertures to the upper chamber, said fluid entering at said inlet, passing through said primary filter to said upper chamber.

2. The pond filter of claim 1, further comprising baffles are disposed in said lower chamber, said rising upwardly from said bottom wall.

3. The pond filter of claim 1, wherein said inlet is disposed just below the primary filter.

4. The pond filter of claim 2, wherein said inlet is above said baffles.

5. The pond filter of claim 2, wherein said inlet is at the same height as said baffles.

6. The pond filter of claim 1, further comprising a shoulder disposed at the upper end of said lower chamber, said shoulder flaring outwardly from said lower chamber, presenting a resting surface for said primary filter.

7. The pond filter of claim 1, further comprising a spout extending outwardly from the upper edge of said upper chamber.

8. The pond filter of claim 1, further comprising gravel disposed in said upper chamber.

9. The pond filter of claim 1, further comprising soil disposed in said upper chamber.

10. The pond filter of claim 1, further comprising root mass disposed in said upper chamber.

11. The pond filter of claim 1, further comprising a water pump, said water pump including a hose for engagement to said inlet.

12. The pond filter of claim 1, further comprising at least one rib encompassing the exterior of said sidewall.

13. A pond filter comprising:
a sidewall having an upper and lower section, said sidewall forming a perimeter and enclosing an interior region;
a bottom wall spanning the lower section of said sidewall, joined said sidewall and said bottom wall defining an enclosure;
a primary filter sealably joined within the sidewall and spanning the width of the interior of the sidewall, defining an upper chamber and a lower chamber;
the primary filter including a plurality of water discharge apertures enabling controlled fluid communication between the upper chamber and lower chamber; and
an inlet disposed on the sidewall portion of the lower chamber, said inlet disposed just below the primary filter, whereby a fluid communication channel is defined from the inlet through the lower chamber through the water discharge apertures to the upper chamber, said fluid entering at said inlet, passing through said primary filter to said upper chamber.

14. The pond filter of claim 13, wherein said inlet is above said baffles.

15. The pond filter of claim 13, further comprising a combination of granular gravel and pebble gravel disposed in said upper chamber.

16. The pond filter of claim 13, further comprising a combination of sand soil and clay soil disposed in said upper chamber.

17. The pond filter of claim 13, further comprising a water pump, said water pump including a hose for engagement to said inlet.

18. A pond filter comprising:
a sidewall having an upper and lower section, said sidewall forming a perimeter and enclosing an interior region;
a bottom wall spanning the lower section of said sidewall, joined said sidewall and said bottom wall defining an enclosure;
a primary filter sealably joined within the sidewall and spanning the width of the interior of the sidewall, defining an upper chamber and a lower chamber;
the primary filter including a plurality of water discharge apertures enabling controlled fluid communication between the upper chamber and lower chamber; and
an inlet disposed on the sidewall portion of the lower chamber, said inlet disposed just below the primary filter, whereby a fluid communication channel is defined from the inlet through the lower chamber through the water discharge apertures to the upper chamber, said fluid entering at said inlet, passing through said primary filter to said upper chamber.

19. The pond filter of claim 18, further comprising a combination of granular gravel, pebble gravel, sand soil, and clay soil disposed in said upper chamber.

20. The pond filter of claim 19, further comprising the root mass of one of a water lily, elephant ears, or a bird of paradise.
